(19) United States
(12) Patent Application Publication
(10) Pub. No.: US 2025/0206561 A1
(43) Pub. Date: Jun. 26, 2025

(54) POST-PROCESSING DEVICE

(71) Applicant: KYOCERA Document Solutions Inc., Osaka (JP)

(72) Inventor: Keisuke EGAWA, Osaka (JP)

(73) Assignee: KYOCERA Document Solutions Inc., Osaka (JP)

(21) Appl. No.: 18/982,927

(22) Filed: Dec. 16, 2024

(30) Foreign Application Priority Data
Dec. 22, 2023 (JP) 2023-216601

(51) Int. Cl. B65H 37/04; B65H 7/20

(52) U.S. Cl. CPC B65H 37/04; B65H 7/20; B65H 2801/27

(57) ABSTRACT

A post-processing device includes a processing tray, a stapler, a movement mechanism, an operation unit and a control unit, the operation unit includes a manual input unit that receives an instruction to perform stapling processing in a manual mode, when a first operation is performed on the manual input unit, the control unit causes the stapler to perform the stapling processing and when a second operation is performed on the manual input unit, the control unit retracts the stapler into a retraction position.

### INCORPORATION BY REFERENCE

This application is based upon and claims the benefit of priority from the corresponding Japanese Patent Application No. 2023-216601 (filed on Dec. 22, 2023), the entire contents of which are incorporated herein by reference.

### BACKGROUND

The present disclosure relates to post-processing devices.

Conventionally, a post-processing device which can perform stapling processing is known. The post-processing device which can perform the stapling processing includes a stapler. In a normal mode, the post-processing device performs the stapling processing on a sheet bundle which has been supplied to an image forming apparatus and on which printing has been performed. In a manual mode, the post-processing device performs the stapling processing on a sheet bundle which is previously prepared.

### SUMMARY

A post-processing device according to a first aspect of the present disclosure is a post-processing device that performs stapling processing for binding, with a staple, a part of a binding margin extending along one side of a sheet bundle, and includes a processing tray, a stapler, a movement mechanism, an operation unit and a control unit. On the processing tray, the sheet bundle is placed such that the direction of the extension of the binding margin is aligned along a predetermined direction. The stapler performs the stapling processing on the sheet bundle on the processing tray. The movement mechanism moves the stapler in the predetermined direction. The operation unit receives an operation related to the stapling processing from a user. The modes of the stapling processing include a normal mode in which the sheet bundle obtained by automatically supplying and stacking sheets on the processing tray is a processing target of the stapling processing and a manual mode in which the sheet bundle that is manually placed on the processing tray by the user is the processing target of the stapling processing. The operation unit includes a manual button that receives an instruction to perform the stapling processing in the manual mode. When a first operation is performed on the manual button, the control unit causes the stapler to perform the stapling processing. When a second operation that is different from the first operation is performed on the manual button, the control unit moves the stapler in the predetermined direction to retract the stapler into a retraction position that is different from a position where the stapling processing can be performed on the binding margin.

### BRIEF DESCRIPTION OF THE DRAWINGS

FIG. 1 is a schematic view of an image forming system which includes a post-processing device according to an embodiment;

FIG. 2 is a schematic view showing the internal configuration of the post-processing device according to the embodiment;

FIG. 3 is a diagram showing positions in which stapling processing is performed by the post-processing device according to the embodiment;

FIG. 4 is a diagram showing a positional relationship between a stapler and a processing tray in the post-processing device according to the embodiment;

FIG. 5 is a perspective view of the stapler and the movement mechanism thereof in the post-processing device according to the embodiment;

FIG. 6 is a perspective view when the base of the stapler in the post-processing device according to the embodiment and an area in the vicinity thereof are viewed from below;

FIG. 7A is a diagram showing positions in which the stapler in the post-processing device according to the embodiment is arranged;

FIG. 7B is a diagram showing positions in which the stapler in the post-processing device according to the embodiment is arranged;

FIG. 7C is a diagram showing positions in which the stapler in the post-processing device according to the embodiment is arranged;

FIG. 8 is a plan view of an operation unit in the post-processing device according to the embodiment;

FIG. 9 is a diagram showing a positional relationship between the stapler and a conveyance guide in the post-processing device in the embodiment;

FIG. 10 is a diagram showing the retraction position of the stapler in the post-processing device according to the embodiment; and

FIG. 11 is a flowchart showing the flow of processing performed by a control unit in the post-processing device according to the embodiment.

### DETAILED DESCRIPTION

### <Outline of Image Forming System>

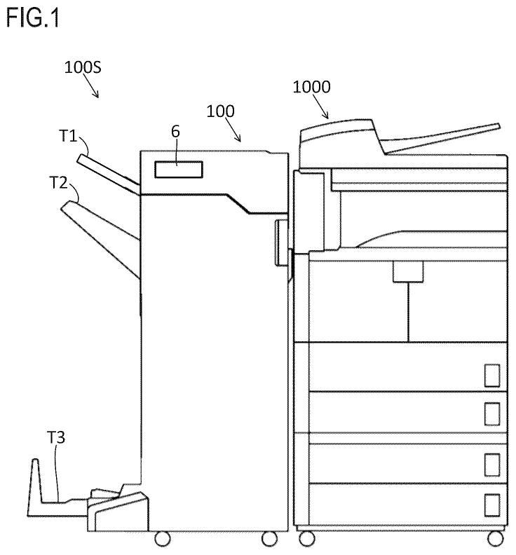

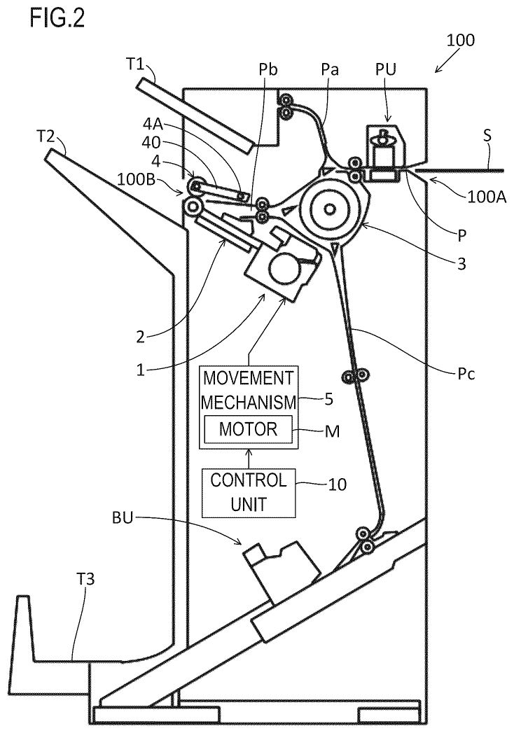

As shown in FIG. 1, a post-processing device 100 in the present embodiment forms an image forming system 100S together with an image forming apparatus 1000. In other words, the post-processing device 100 includes the image forming apparatus 1000. The image forming system 100S performs a print job. In the print job, printing is performed in the image forming apparatus 1000, a sheet S (see FIG. 2) on which the printing has been performed is conveyed into the post-processing device 100 and post-processing is performed in the post-processing device 100. In this configuration, the image forming apparatus 1000 serves as a supply device which supplies the sheet S to the post-processing device 100. A device which is different from the image forming apparatus 1000 may be the supply device. The supply device does not need to have a printing function. For example, the sheet S on which the printing has been performed may be supplied to the supply device, and the sheet S may be supplied to the post-processing device 100.

The image forming apparatus 1000 conveys the sheet S, and prints an image on the sheet S being conveyed. The printing system of the image forming apparatus 1000 is not particularly limited. The printing system may be an electrophotographic system or an inkjet system. The image forming apparatus 1000 conveys the sheet S on which the printing has been performed into the post-processing device 100.

The post-processing device 100 is coupled to the image forming apparatus 1000. The post-processing device 100 is removable with respect to the image forming apparatus 1000. The post-processing device 100 receives the conveyance of the sheet S on which the printing has been performed from the image forming apparatus 1000. Hence, the post-processing device 100 is arranged on a downstream side in a sheet conveyance direction with respect to the image forming apparatus 1000.

The post-processing device 100 conveys the sheet S on which the printing has been performed to perform post-processing such as punching processing and stapling processing on the sheet S (including a sheet bundle SB which will be described later). The post-processing device 100 ejects the sheet S on which the post-processing has been performed.

The post-processing device 100 performs the post-processing based on a setting made by a user. Depending on the details of the setting made by the user, the sheet S may be ejected from the post-processing device 100 without the post-processing being performed in the post-processing device 100 on the sheet S on which the printing has been performed.

A configuration may be adopted in which the post-processing device 100 can be used singly without being coupled to the image forming apparatus 1000. In this case, for example, in the post-processing device 100, a set tray is provided. The sheet S which is set on the set tray is automatically conveyed into the post-processing device 100, and the post-processing device 100 performs the post-processing.

### <Configuration of Post-Processing Device>

The internal configuration of the post-processing device 100 is shown in FIG. 2. The direction of the post-processing device 100 shown in FIG. 2 corresponds to the direction when the post-processing device 100 is viewed from the front of the device. In the following description, “left” and “right” refer to a direction when the post-processing device 100 is viewed from the front of the device. In the following description, “front” and “back” refer to a direction when the post-processing device 100 is viewed from the front of the device.

As shown in FIG. 2, the post-processing device 100 conveys, along a conveyance path P, the sheet S which has been conveyed from a carry-in port 100A and on which the printing has been performed. In order to convey the sheet S along the conveyance path P, a plurality of conveyance roller pairs (the symbols of which are omitted) are provided in the post-processing device 100. The conveyance roller pair includes a pair of rollers which are pressed against each other. In the conveyance roller pair, the sheet S is nipped between the pair of rollers, and in this state, the conveyance roller pair is rotated to convey the sheet S.

The post-processing device 100 includes a control unit 10. The control unit 10 includes a processing circuit of a CPU and the like. The control unit 10 also includes a storage unit of a ROM, a RAM and the like. The control unit 10 controls the post-processing device 100.

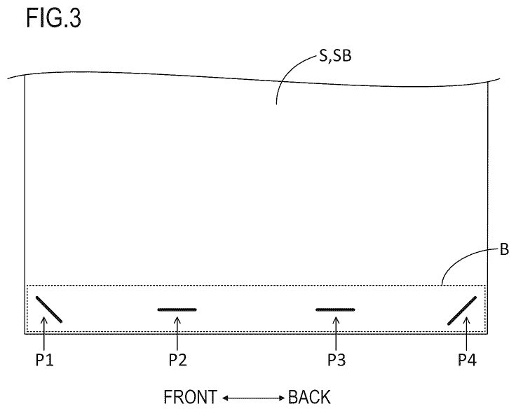

Here, the post-processing device 100 includes a stapler 1. The stapler 1 is a unit which performs the stapling processing as the post-processing. The control unit 10 controls the stapler 1. The stapler 1 performs the stapling processing in locations shown in FIG. 3 on the sheet bundle SB including a plurality of sheets S stacked. Specifically, the stapler 1 binds, with staples, parts of a binding margin B which extends along one side of the sheet bundle SB.

For example, the stapling processing can be performed in four positions of the binding margin B. In FIG. 3, the four positions are identified with symbols P1, P2, P3 and P4, respectively. In FIG. 3, the region of the binding margin B is surrounded by dashed lines, and the positions of the binding margin B where the staples are inserted are indicated by thick lines.

The post-processing device 100 may include other units as units for performing the post-processing. For example, the post-processing device 100 includes a punch unit PU and a booklet unit BU as the units for performing the post-processing. The punch unit PU performs the punching processing on the sheet S. The booklet unit BU performs folding processing on the sheet S.

The conveyance path P has the processing position of the punch unit PU in the vicinity of the carry-in port 100A (that is, on the upstream side of the conveyance path P in the sheet conveyance direction). The conveyance path P branches into three paths on the downstream side in the sheet conveyance direction with respect to the processing position of the punch unit PU. In the following description, the three conveyance paths P are identified with symbols Pa, Pb and Pc, respectively.

The conveyance path Pa is connected to an ejection tray T1. When the stapling processing and the folding processing are not performed, the sheet S which has been passed through the punch unit PU is ejected to the ejection tray T1 via the conveyance path Pa.

The conveyance path Pb is connected to an ejection tray T2 which is different from the ejection tray T1. A processing tray 2 is provided partway through the conveyance path of the sheet S leading to the ejection tray T2 (in a position immediately in front of the ejection tray T2). In other words, the post-processing device 100 includes the processing tray 2.

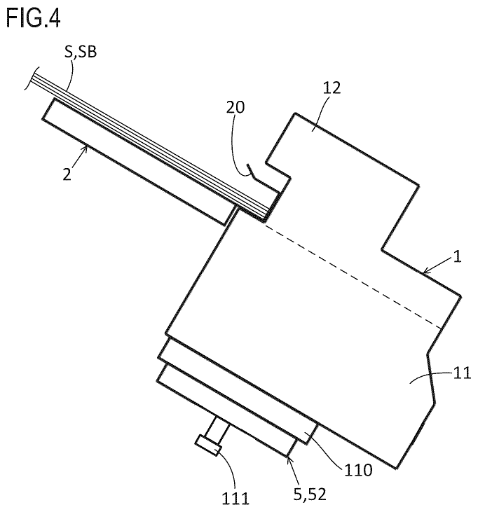

In a print job including the stapling processing, the sheet S is drawn from the conveyance path Pb into the processing tray 2. On the processing tray 2, a plurality of sheets S are stacked. In other words, the sheet bundle SB is placed on the processing tray 2. A state where the sheet bundle SB is placed on the processing tray 2 is shown in FIG. 4.

The sheet bundle SB is placed on the processing tray 2 such that the direction of extension of the binding margin B is aligned along a predetermined direction. On the processing tray 2, the binding margin B of the sheet bundle SB extends in a forward/backward direction. In other words, the forward/backward direction corresponds to the “predetermined direction”.

The conveyance path Pc is connected to the booklet unit BU. When the folding processing is performed as the post-processing, the post-processing device 100 conveys the sheet S to the booklet unit BU via the conveyance path Pc. The booklet unit BU performs booklet processing on the sheet S which has been fed via the conveyance path Pc. Then, the booklet unit BU ejects the sheet S to an ejection tray T3 for the booklet processing. In other words, a booklet obtained by performing the booklet processing is ejected to the ejection tray T3.

In the branch position of the conveyance path P, a retraction mechanism 3 which temporarily retracts the sheet S is provided. The retraction mechanism 3 includes a retraction drum. The retraction mechanism 3 winds the sheet S around the retraction drum to retract the sheet S. In this way, it is possible to delay the conveyance of the sheet S to the processing tray 2.

In the print job including the stapling processing, the sheet S is conveyed from the retraction mechanism 3 toward the ejection tray T2. The processing tray 2 is arranged partway through the conveyance path of the sheet S leading from the retraction mechanism 3 to the ejection tray T2.

The processing tray 2 is inclined obliquely downward from the downstream side to the upstream side in the sheet conveyance direction. In other words, the processing tray 2 is inclined obliquely downward from one end side thereof to the other end side. When viewed from the front of the post-processing device 100 (that is, when viewed in the forward/backward direction), the left end of the processing tray 2 is the one end, and the right end of the processing tray 2 is the other end. Hence, when viewed from the front of the post-processing device 100, the processing tray 2 is inclined obliquely downward to the right side from the left side.

On the left end side of the processing tray 2, an ejection port 100B which is open toward the ejection tray T2 is provided. On the left end side of the processing tray 2, an ejection roller pair 4 is also provided. The ejection roller pair 4 includes an upper roller and a lower roller which are pressed against each other. The upper roller is arranged on the upper side of the conveyance path of the sheet S, and the lower roller is arranged on the lower side of the conveyance path of the sheet S. The upper roller and the lower roller are opposite each other through the conveyance path of the sheet S. The ejection roller pair 4 nips the sheet S between the upper roller and the lower toller, and in this state, the ejection roller pair 4 is rotated. In this way, the sheet S or the sheet bundle SB is ejected via the ejection port 100B to the ejection tray T2.

For example, the upper roller of the ejection roller pair 4 is rotatably supported to one end of an arm 40. The other end of the arm 40 is rotatably supported to a rotation shaft 4A. The arm 40 can be turned such that one end swings vertically with the rotation shaft 4A used as a support point. The arm 40 is turned in an upward direction, and thus the upper roller can be separated from the lower roller. The arm 40 is turned in a downward direction, and thus the upper roller can be caused to approach the lower roller.

In the processing tray 2, a stopper 20 (see FIG. 4) is provided. The stopper 20 is arranged on the right end side of the processing tray 2. The stopper 20 extends to the right side with respect to the right end of the processing tray 2. The stopper 20 is formed substantially in the shape of the letter U when viewed from the front of the post-processing device 100.

In the print job including the stapling processing, the sheet S enters between the upper roller and the lower roller in a state where the upper roller of the ejection roller pair 4 is separated from the lower roller. Thereafter, for example, an unillustrated paddle is operated, and thus the sheet S is moved obliquely downward along the placement surface of the processing tray 2 (the surface on which the sheets S are stacked). Alternatively, the sheet S moves obliquely downward along the placement surface of the processing tray 2 under its own weight. Then, the back end of the sheet S makes contact with the stopper 20, and thus the movement of the sheet S obliquely downward is stopped. In this way, the back ends of a plurality of sheets S are aligned.

The stapler 1 is arranged on the right end side of the processing tray 2. The stapler 1 includes a main body 11 and a movable portion 12 (see FIG. 4). The movable portion 12 is attached to the main body 11. The stapler 1 moves the movable portion 12 with respect to the main body 11, and thus the sheet bundle SB is sandwiched between the main body 11 and the movable portion 12. Then, the stapler 1 performs the stapling processing on the back end of the sheet bundle SB.

After the completion of the stapling processing, the upper roller of the ejection roller pair 4 approaches the lower roller, and thus the sheet bundle SB on the processing tray 2 is sandwiched between the upper roller and the lower roller. In this state, the ejection roller pair 4 is rotated. In this way, the sheet bundle SB is ejected via the ejection port 100B to the ejection tray T2.

### <Movement Mechanism of Stapler>

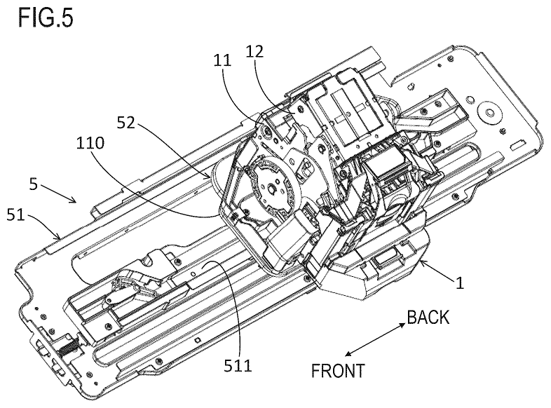

The post-processing device 100 includes a movement mechanism 5 as shown in FIG. 5. The movement mechanism 5 shown in FIG. 5 is an example, and the configuration of the movement mechanism 5 is not particularly limited.

The movement mechanism 5 moves the stapler 1 in the forward/backward direction. In this way, the stapler 1 can be moved along the direction of extension of the binding margin B of the sheet bundle SB on the processing tray 2. The stapler 1 is moved in the forward/backward direction, and thus it is possible to selectively perform the stapling processing on the positions P1, P2, P3 and P4.

The movement mechanism 5 includes a base portion 51 and a movement portion 52. The movement mechanism 5 also includes a motor M (see FIG. 2).

The base portion 51 supports the movement portion 52 such that the movement portion 52 can be moved in the forward/backward direction. The base portion 51 guides the movement of the movement portion 52 in the forward/backward direction. The base portion 51 includes a guide groove 511.

The movement portion 52 is attached to a seamless belt which is stretched over a plurality of pulleys though they are not shown in the figure. One of the pulleys is coupled to the motor M. The motor M is driven, and thus the seamless belt is rotated. In this way, the motor M is driven, and thus the movement portion 52 is moved in the forward/backward direction.

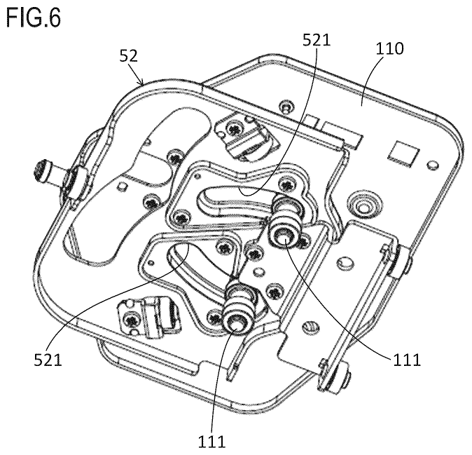

The stapler 1 includes a base 110. The base 110 is supported by the movement portion 52. In this way, the movement portion 52 is moved in the forward/backward direction, and thus the stapler 1 is moved in the forward/backward direction. As shown in FIG. 6, the base 110 includes two guide pins 111. The two guide pins 111 are respectively inserted into guide holes 521 which are through holes formed in the movement portion 52, and are fitted into the guide groove 511. Each of the guide holes 521 is extended in the shape of an arc in a direction orthogonal to the direction of penetration thereof. In other words, each of the guide holes 521 includes an arc-shaped opening when viewed in the direction of penetration thereof.

The control unit 10 controls the driving of the motor M. In other words, the control unit 10 controls the movement mechanism 5. Furthermore, in other words, the control unit 10 controls the movement of the stapler 1 in the forward/backward direction.

The control unit 10 moves the stapler 1 in the forward/backward direction such that it is possible to perform the stapling processing on a position indicated by the user in the binding margin B of the sheet bundle SB (that is, the positions P1 to P4), and causes the stapler 1 to perform the stapling processing on the position indicated by the user. In the following description, the position where the stapling processing is performed on the binding margin B of the sheet bundle SB is simply referred to as a stapling position.

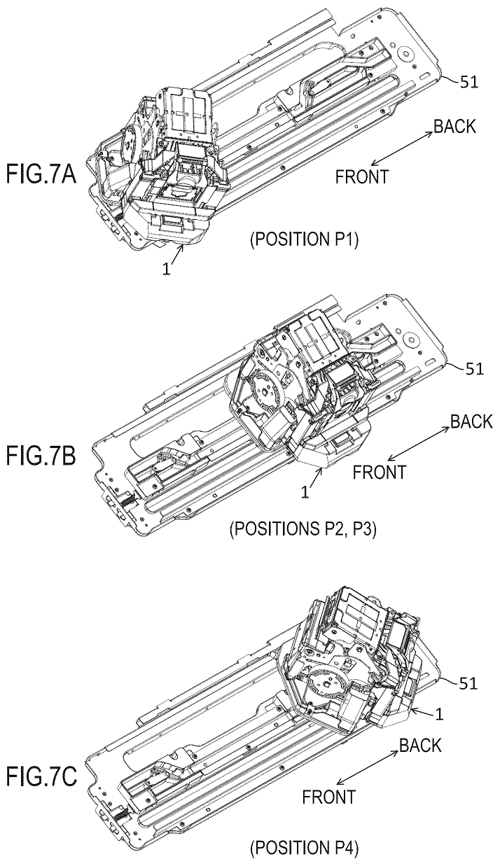

When the stapling position is the position P1, the stapler 1 is moved to a position shown in FIG. 7A. When the stapling position is the positions P2 and P3, the stapler 1 is moved to a position shown in FIG. 7B. When the stapling position is the position P4, the stapler 1 is moved to a position shown in FIG. 7C.

### <Mode of Stapling Processing>

As the modes of the stapling processing, a normal mode and a manual mode are provided.

The normal mode is a mode in which the sheet bundle SB obtained by automatically supplying sheets S from the image forming apparatus 1000 and stacking the sheets S on the processing tray 2 is the processing target of the stapling processing. In other words, when the print job including the stapling processing is performed, the mode of the stapling processing is the normal mode.

In the normal mode, the stapling processing is automatically performed on the sheet bundle SB on the processing tray 2 without the user providing an instruction to perform the stapling processing. Then, the sheet bundle SB on which the stapling processing has been performed is automatically ejected to the ejection tray T2.

In the normal mode, a setting for the stapling position is made by the user as one of settings in the print job. When an instruction to perform the print job is provided to the image forming system 100S from a user terminal such as a personal computer, the setting for the stapling position can be made with the user terminal. When a copy job is performed as the print job by the image forming system 100S, the setting for the stapling position can be made with an operation panel in the image forming apparatus 1000.

The manual mode is a mode in which the sheet bundle SB that is manually placed on the processing tray 2 by the user is the processing target of the stapling processing. Hence, in the manual mode, the sheet S is not supplied from the image forming apparatus 1000 to the post-processing device 100. In the manual mode, the setting for the print job is not needed. In other words, an operation which is performed on the operation panel (not shown) in the image forming apparatus 1000 is not needed.

In the manual mode, the user places the sheet bundle SB on the processing tray 2 from the outside of the post-processing device 100. For example, when the image forming system 100S including the post-processing device 100 is in a standby state, the upper roller and the lower roller of the ejection roller pair 4 are separated from each other. In other words, the sheet bundle SB can be placed on the processing tray 2 via the ejection port 100B from the outside of the post-processing device 100.

In the manual mode, after the sheet bundle SB is placed on the processing tray 2, the following operation is performed by the user.

When the sheet bundle SB is placed on the processing tray 2, the user operates an operation unit 6 which will be described later to provide an instruction to perform the stapling processing. When the operation unit 6 receives the instruction to perform the stapling processing, the control unit 10 causes the stapler 1 to perform the stapling processing. After the completion of the stapling processing, the upper roller and the lower roller of the ejection roller pair 4 nip the sheet bundle SB to rotate. In this way, the sheet bundle SB on which the stapling processing has been performed is ejected to the ejection tray T2.

### <Operation Unit in Post-Processing Device>

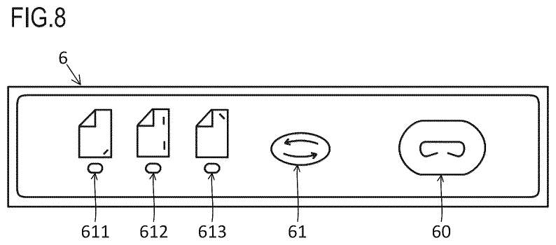

The post-processing device 100 includes the operation unit 6 as shown in FIG. 8. The operation unit 6 receives, from the user, various settings related to the stapling processing in the manual mode. The operation unit 6 is operated, and thus it is possible to make settings for the stapling processing in the manual mode.

The operation unit 6 includes a position setting button 61 which receives a setting for the stapling position in the manual mode. The position setting button 61 is a hardware button. The operation unit 6 may be formed with a touch screen, and an operation reception image such as a software button corresponding to the position setting button 61 may be displayed on the touch screen. The position setting button 61 is operated, and thus it is possible to switch the stapling position. The operation unit 6 includes indicator lights 611, 612 and 613 which indicate the current setting for the stapling position.

When the current setting for the stapling position is the position P1, the position setting button 61 is pressed down to switch the stapling position from the position P1 to the positions P2 and P3. When the current setting for the stapling position is the positions P2 and P3, the position setting button 61 is pressed down to switch the stapling position from the positions P2 and P3 to the position P4. When the current setting for the stapling position is the position P4, the position setting button 61 is pressed down to switch the stapling position from the position P4 to the position P1.

When the current setting for the stapling position is the position P1, the indicator light 611 corresponding to the position P1 is turned on. When the current setting for the stapling position is the positions P2 and P3, the indicator light 612 corresponding to the positions P2 and P3 is turned on. When the current setting for the stapling position is the position P4, the indicator light 613 corresponding to the position P4 is turned on. For example, in the normal mode, all the indicator lights 611 to 613 are turned off.

The operation unit 6 also includes a manual button 60 which receives an instruction to perform the stapling processing in the manual mode. The manual button 60 corresponds to a “manual input unit”. The manual button 60 is a hardware button. The operation unit 6 may be formed with a touch screen, and an operation reception image (that is, an image corresponding to the “manual input unit”) such as a software button corresponding to the manual button 60 may be displayed on the touch screen.

The control unit 10 determines whether a first operation has been performed on the manual button 60. When the control unit 10 determines that the first operation has been performed on the manual button 60, the control unit 10 causes the stapler 1 to perform the stapling processing on the sheet bundle SB on the processing tray 2.

### <Retraction of Stapler>

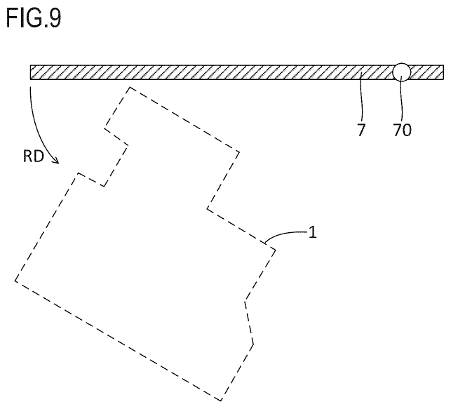

The post-processing device 100 includes a conveyance guide 7 (see FIG. 9). The conveyance guide 7 guides the conveyance of the sheet S. The conveyance guide 7 is arranged on the lower side of the conveyance path of the sheet S. In other words, the sheet S is conveyed along the upper surface of the conveyance guide 7. FIG. 9 is a diagram schematically showing the conveyance guide 7 and an area in the vicinity thereof.

When jam processing is performed on the sheet S in the post-processing device 100, the conveyance path of the sheet S needs to be opened. For example, the conveyance guide 7 is supported by a shaft pin 70, and can be turned downward (in a RD direction in FIG. 9) with the shaft pin 70 used as a support point. The conveyance guide 7 is turned downward, and thus the conveyance path of the sheet S defined by the conveyance guide 7 is opened. In this way, it is possible to remove the sheet S which is stuck in the conveyance path defined by the conveyance guide 7.

When maintenance is needed in the post-processing device 100, a maintenance operation is performed from the front side of the post-processing device 100 (the front of the device). In the maintenance operation, for example, a hand is inserted into the post-processing device 100 from the front side thereof.

Here, in the jam processing, the maintenance operation or the like, when the stapler 1 is arranged in a position where the stapling processing can be performed on the binding margin B of the sheet bundle SB (that is, the positions P1 to P4), the stapler 1 is an obstacle to the operation. Hence, a retraction position into which the stapler 1 is retracted is secured inside the post-processing device 100. The retraction position of the stapler 1 is different from the position where the stapling processing can be performed on the binding margin B of the sheet bundle SB. In other words, the retraction position of the stapler 1 is different from the position where the stapler 1 can be arranged when the stapling processing is performed.

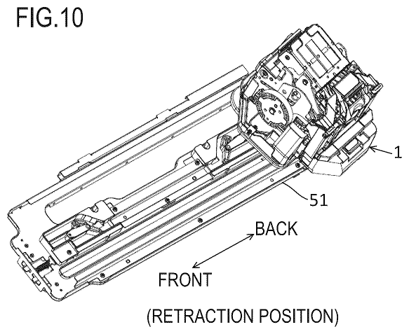

Specifically, the retraction position of the stapler 1 is secured in a back side of the interior of the post-processing device 100. Among the positions P1 to P4, the position of arrangement of the stapler 1 when the stapling processing is performed on the position P4 is the backmost side. Hence, as shown in FIG. 10, the retraction position of the stapler 1 is a position on the back side with respect to the position of arrangement of the stapler 1 (position shown in FIG. 7C) when the stapling processing is performed on the position P4.

The stapler 1 is retracted into the retraction position, and thus the conveyance guide 7 can be turned downward. In this way, the conveyance path of the sheet S defined by the conveyance guide 7 can be opened, and thus the jam processing can be performed. The stapler 1 is retracted into the retraction position, and thus the maintenance operation can be performed from the front side of the post-processing device 100.

### <First Operation and Second Operation>

The manual button 60 is a button which receives, from the user, the instruction to perform the stapling processing in the manual mode. Here, the manual button 60 also functions as a button which receives, from the user, an instruction to retract the stapler 1 into the retraction position.

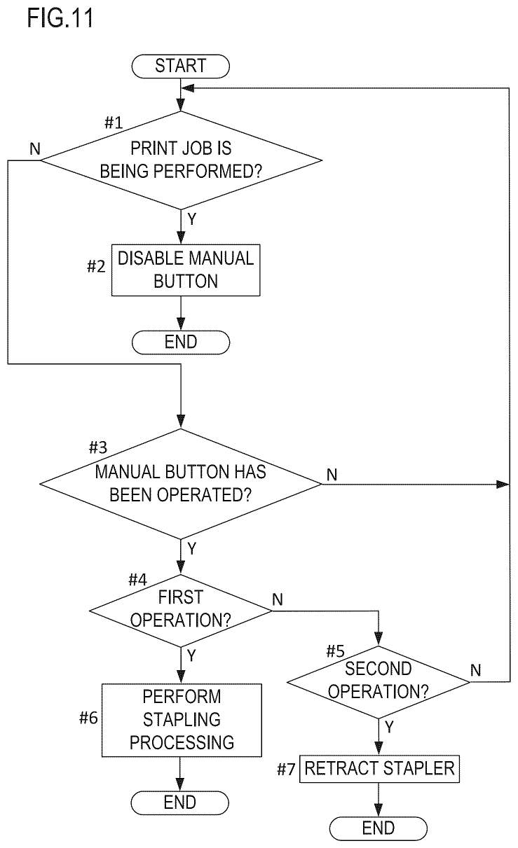

A specific description will be given below with reference to a flowchart shown in FIG. 11. At the start of the flow shown in FIG. 11, it is likely that the print job is being performed, and thus the sheet S is conveyed from the image forming apparatus 1000 into the post-processing device 100. It is also likely that the sheet S is not conveyed from the image forming apparatus 1000 into the post-processing device 100. That the sheet S is not conveyed from the image forming apparatus 1000 into the post-processing device 100 means that the print job is not being performed, and each of the post-processing device 100 and the image forming apparatus 1000 is on standby.

In step #1, the control unit 10 determines whether the print job is being performed. When the control unit 10 determines that the print job is being performed, the processing transfers to step #2. In step #2, the control unit 10 disables an operation performed on the manual button 60. In other words, when the mode of the stapling processing is the normal mode, the control unit 10 disables the operation performed on the manual button 60. In this way, while the print job is being performed, even when the manual button 60 is pressed down, no response is made to the pressing down. Consequently, while the print job is being performed, even when the user erroneously operates the manual button 60, the erroneous operation of the stapler 1 can be suppressed.

When in step #1, the control unit 10 determines that the print job is not being performed, that is, that the post-processing device 100 is on standby, the processing transfers to step #3. In step #3, the control unit 10 determines whether the manual button 60 has been operated. When the control unit 10 determines that the manual button 60 has been operated, the processing transfers to step #4. When the control unit 10 determines that the manual button 60 has not been operated, the processing transfers to step #1.

In step #4, the control unit 10 determines whether the operation performed on the manual button 60 is the first operation. When the control unit 10 determines that the operation performed on the manual button 60 is not the first operation, the processing transfers to step #5. In step #5, the control unit 10 determines whether the operation performed on the manual button 60 is a second operation.

Here, the first operation and the second operation will be described.

The control unit 10 detects, as the first operation, an operation of pressing down the manual button 60 only once within a predetermined time. For example, the predetermined time is one to several seconds. In other words, when an operation of pressing down the manual button 60 and immediately releasing it is performed, such an operation is detected as the first operation.

The control unit 10 detects, as the second operation, a predetermined operation which is different from the first operation. One operation may be detected as the second operation or a plurality of operations may be detected as the second operation.

The control unit 10 detects, as the second operation, an operation of continuing to press down the manual button 60 until the elapse of a predetermined first time. In other words, the control unit 10 detects, as the second operation, a long press operation on the manual button 60. The first time may be the same as or different from the predetermined time.

The control unit 10 detects, as the second operation, an operation of pressing down the manual button 60 a plurality of times before the elapse of a predetermined second time. In other words, the control unit 10 detects, as the second operation, a series of pressing operations on the manual button 60. For example, the number of pressing operations is two or three. The second time may be the same as or different from the predetermined time. The second time may be the same as or different from the first time.

Only one of the long press operation and the series of pressing operations on the manual button 60 may be detected as the second operation or both of them may be detected as the second operation. When only one of the long press operation and the series of pressing operations is detected as the second operation, even if the other one is performed, such an operation is disabled. When both of the long press operation and the series of pressing operations are detected as the second operation, unless an abnormality in the operation detection or the like occurs, the disabling of the operation can be suppressed.

When in step #4, the control unit 10 determines that the operation performed on the manual button 60 is the first operation, the processing transfers to step #6. In step #6, the control unit 10 determines that the operation performed on the manual button 60 is an instruction to perform the stapling processing in the manual mode. Hence, when the processing transfers to step #6, the control unit 10 causes the stapler 1 to perform the stapling processing.

When in step #5, the control unit 10 determines that the operation performed on the manual button 60 is the second operation, the processing transfers to step #7. In step #7, the control unit 10 determines that the operation performed on the manual button 60 is an instruction to retract the stapler 1. Hence, when the processing transfers to step #7, the control unit 10 moves the stapler 1 in the forward/backward direction (specifically in the backward direction), and thus the stapler 1 is retracted into the retraction position.

When in step #5, the control unit 10 determines that the operation performed on the manual button 60 is not the second operation, the processing transfers to step #1.

In the present embodiment, the first operation performed on the manual button 60 is received as the instruction to perform the stapling processing in the manual mode. On the other hand, the second operation performed on the manual button 60 is received as the instruction to retract the stapler 1 into the retraction position. In this configuration, it is not necessary to separately provide the button for receiving the instruction to perform the stapling processing in the manual mode and the button for receiving the instruction to retract the stapler 1. In other words, with only one button (which is the manual button 60), it is possible to receive both the instruction to perform the stapling processing in the manual mode and the instruction to retract the stapler 1.

In this way, for example, in a configuration in which the button for receiving, from the user, the instruction to perform the stapling processing in the manual mode is provided, when specifications are changed such that the instruction to retract the stapler 1 can be received from the user, it is possible to receive the instruction to retract the stapler 1 from the user without adding a button for receiving the instruction to retract the stapler 1. In other words, it is possible to receive the instruction to retract the stapler 1 from the user without increasing the number of buttons installed for receiving an operation from the user. The number of buttons installed is not increased, and thus the configuration of the operation unit 6 is simplified. Moreover, it is not necessary to change the design of the operation unit 6.

The operation (long press operation) of continuing to press down the manual button 60 until the elapse of the first time is detected as the second operation, and thus the first operation and the second operation can easily be differentiated. Furthermore, the operation (series of pressing operations) of pressing down the manual button 60 a plurality of times before the elapse of the second time is detected as the second operation, and thus the first operation and the second operation can easily be differentiated. The long press operation and the series of pressing operations are general operations. Hence, when the user performs the jam processing and the maintenance operation, the user can retract the stapler 1 by performing the simple operation, with the result that convenience is enhanced.

The embodiment disclosed herein should be considered to be illustrative in all respects and not restrictive. The scope of the present disclosure is indicated not by the description of the embodiment but by the scope of claims, and furthermore, meanings equivalent to the scope of claims and all changes in the scope are included therein.

For example, the operation unit may be arranged in the image forming apparatus. The entire image forming system including the image forming apparatus may be provided as the post-processing device.

What is claimed is:

1. A post-processing device that performs stapling processing for binding, with a staple, a part of a binding margin extending along one side of a sheet bundle, the post-processing device comprising:
a processing tray on which the sheet bundle is placed such that a direction of the extension of the binding margin is aligned along a predetermined direction;
a stapler that performs the stapling processing on the sheet bundle on the processing tray;
a movement mechanism that moves the stapler in the predetermined direction;
an operation unit that receives an operation related to the stapling processing from a user; and
a control unit,
wherein modes of the stapling processing include
a normal mode in which the sheet bundle obtained by automatically supplying and stacking sheets on the processing tray is a processing target of the stapling processing and
a manual mode in which the sheet bundle that is manually placed on the processing tray by the user is the processing target of the stapling processing,
the operation unit includes a manual input unit that receives an instruction to perform the stapling processing in the manual mode,
when a first operation is performed on the manual input unit, the control unit causes the stapler to perform the stapling processing and
when a second operation that is different from the first operation is performed on the manual input unit, the control unit moves the stapler in the predetermined direction to retract the stapler into a retraction position that is different from a position where the stapling processing can be performed on the binding margin.

2. The post-processing device according to claim 1,
wherein the control unit detects, as the second operation, an operation of continuing to press down the manual input unit until elapse of a first time.

3. The post-processing device according to claim 1,
wherein the control unit detects, as the second operation, an operation of pressing down the manual input unit a plurality of times before elapse of a second time.

4. The post-processing device according to claim 1,
wherein when the mode of the stapling processing is the normal mode, the control unit disables an operation performed on the manual input unit.

5. The post-processing device according to claim 1, further comprising:
an image forming apparatus that prints an image on the sheet,
wherein the stapling processing is performed on the sheet which has been supplied from the image forming apparatus and on which the printing has been performed.
